(19) United States
(12) Patent Application Publication
(10) Pub. No.: US 2005/0086524 A1
(43) Pub. Date: Apr. 21, 2005

(54) Systems and methods for providing network security with zero network footprint

(75) Inventor: Robert E. Cavanaugh, Encinitas, CA (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Deep Nines Incorporated, Dallas, TX (US)

(21) Appl. No.: 10/687,413

(22) Filed: Oct. 16, 2003

(51) Int. Cl. G06F 11/30

(52) U.S. Cl. 713/201

(57) ABSTRACT

The present invention is directed to a system and method which essentially hides the protection device from the public network, while still allowing the device to perform security inspections. The system and method, in one embodiment, operates in the promiscuous mode and does not have a physical address that is identifiable to any internal or external device, and is thus not available for direct attacks. Using this approach, every data packet flowing into the protected system can be viewed and actions taken to protect the network while the device remains free of the threat of a direct attack.

### CROSS-REFERENCE TO RELATED APPLICATIONS

The present application is related to filed, co-pending, and commonly assigned U.S. patent application Ser. No. 09/572,112, filed on May 17, 2000, entitled “INTELLIGENT FEEDBACK LOOP PROCESS CONTROL SYSTEM”; U.S. patent application Ser. No. 09/875,319, filed on Jun. 6, 2001, entitled “SYSTEM AND METHOD FOR TRAFFIC MANAGEMENT CONTROL IN A DATA TRANSMISSION NETWORK”; and U.S. patent application Ser. No. 10/078,386, filed on Feb. 20, 2002, entitled “SYSTEM AND METHOD FOR DETECTING AND ELIMINATING IP SPOOFING IN A DATA TRANSMISSION NETWORK” the disclosures of which are all hereby incorporated herein by reference.

### TECHNICAL FIELD

This invention relates to network security and more particularly to a system and method for providing network security without leaving a networking footprint.

### BACKGROUND OF THE INVENTION

The problem in the industry for security products and security appliances platforms is their vulnerability to hackers. This vulnerability comes, in part, because the security products and platforms themselves have a physical identification and are thus identifiable by hackers. Since the physical address is visible to internet network routers, data (often destructive type data) can be directed to the security device itself, even if the device is located internally, i.e. on the enterprise side of the firewall. Once the address of the security device is known, hackers use the address as a destination for attacks or malicious behavior towards that particular device or system. This type of action compromises the integrity of the security device and exposes the network that is supposedly being protected by the device.

There are usually two types of addresses for devices connected to the internet. The first is a network layer address, called the IP address, and the second is a media access controller (MAC) address which identifies the actual network interface card, (NIC) through which communication flows. Knowledge by a hacker of either of these addresses is a problem.

The purpose of these addresses is so that traffic can be directed to and from the hardware address. The hardware (for example, a security device), having a particular address, gets data packets bearing that particular address and passes that data along downstream to other equipment. Thus, by sending bad packets to an address, the router (or other device at that address) passes the packets downstream thereby disabling the network.

### BRIEF SUMMARY OF THE INVENTION

The present invention is directed to a system and method which essentially hides the protection device from the public network, while still allowing the device to perform security inspections. The system and method does not have a physical address that is identifiable to any internal or external device, and is thus invisible and not available for direct attacks. Using this approach, every data packet flowing into the protected system can be viewed and since the security device does not have a routing address (zero network footprint), it remains immune from direct attacks.

One technical advantage is that installation is relatively easy since there is no need to reconfigure the user's network to include a security device having an address. This then allows for “hot” installation, relocation, and/or removal, if desired.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of the system and method discussed herein; and

FIG. 2 shows a prior art system of operation.

### DETAILED DESCRIPTION OF THE INVENTION

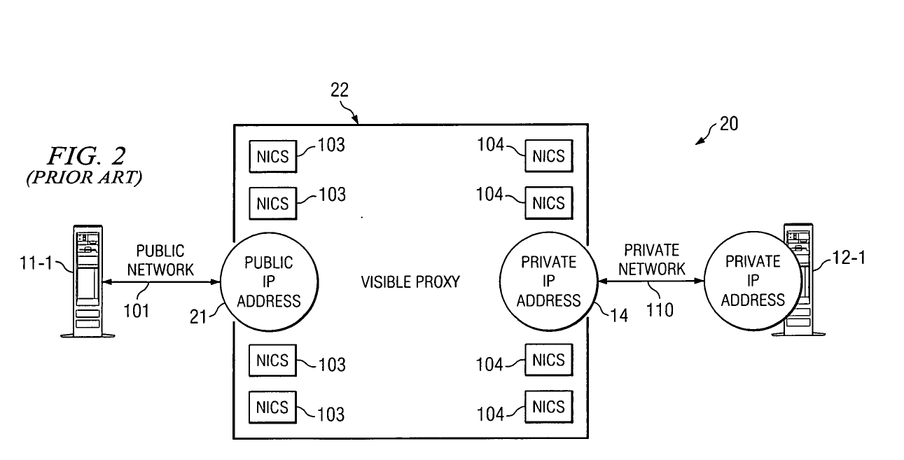

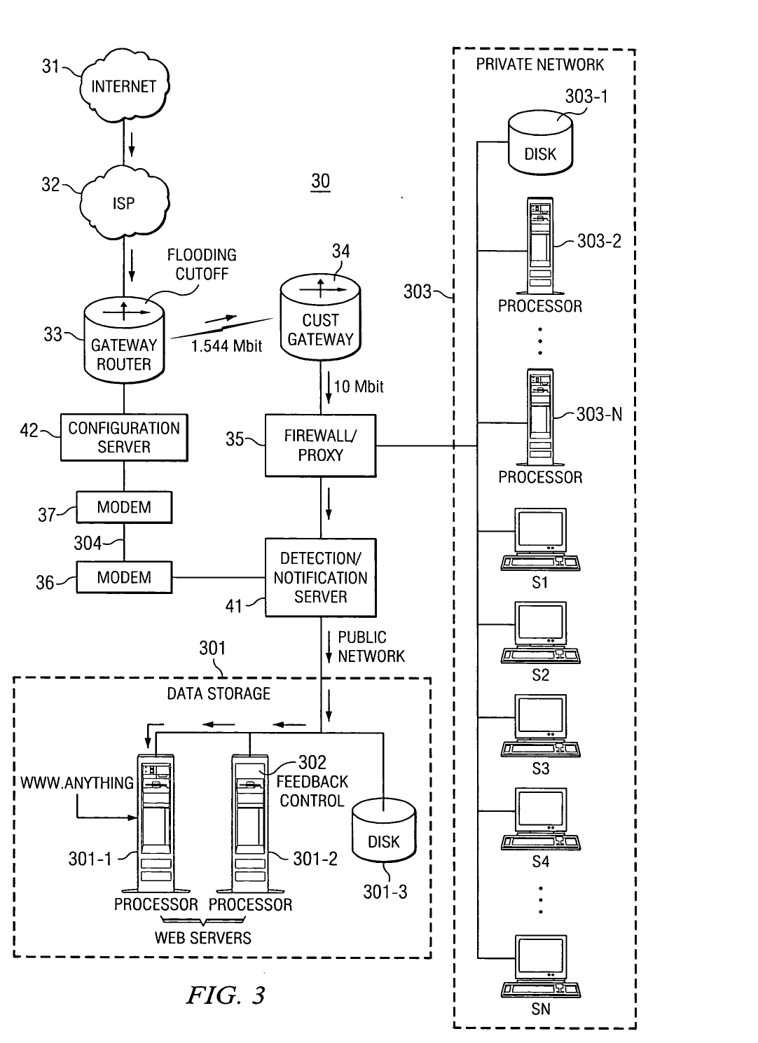

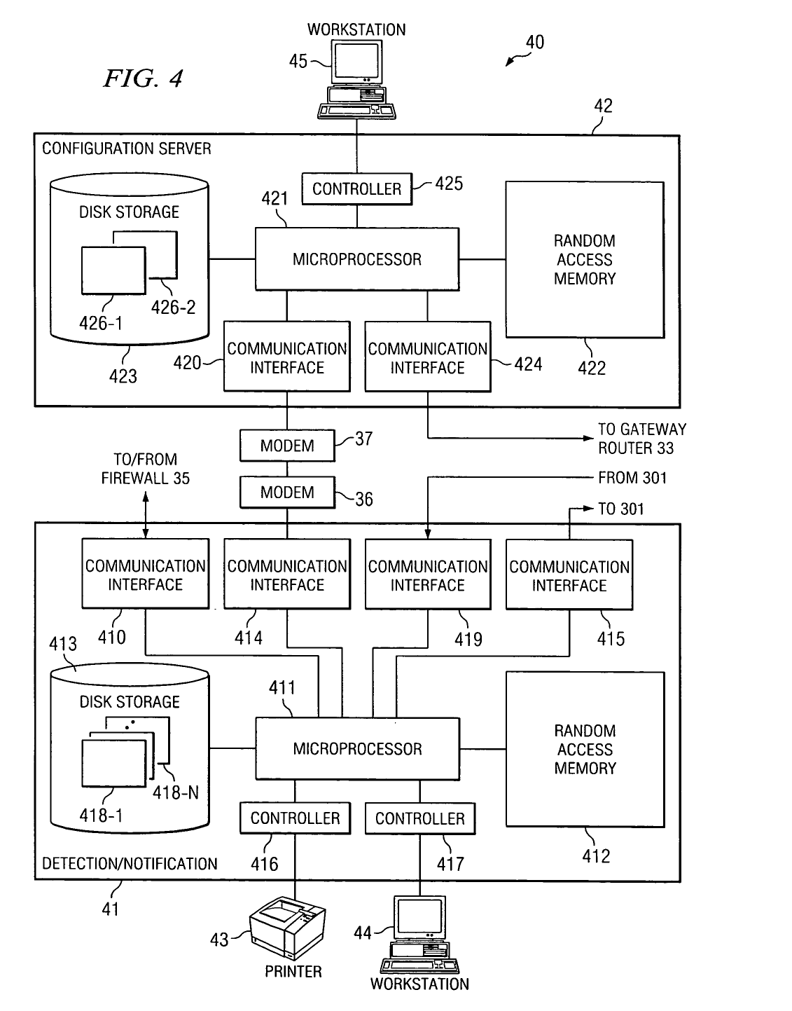

Before beginning the detailed description of the operational aspects of the system and method of this invention, it might be helpful to review the operation of a prior art system 20 with respect to FIG. 2.

In such a system, a sending device, such as server 11-1, would send a packet, or packets, of data over public network 101 to a specific location. The specific location would have public IP address 21. Public IP address 21, in turn, will be the input to proxy 22 which includes within it information pertaining to addresses within the protected network.

Note that since proxy 22 IP address is known to server 11-1 it is called a visible proxy. Visible proxy 22, in turn, then as discussed, forwards this information to private IP address 14 over private network 102 to any one of the number of private IP addresses which in effect are at the destination, devices at such at the destination server 12-1.

Physical proxy 22 operates to remove from the incoming data stream all data that it perceives to be improper. However, as discussed above, since visible proxy 22 itself is known to the public, it is vulnerable to attacks from server 11-1 or from any other device connected to the public network, thereby effectively inhibiting the efficient functioning of proxy 22 by overloading its input. As discussed, other attacks can be made on address 21 if address 21 is known, thereby eliminating the effectiveness of proxy 22.

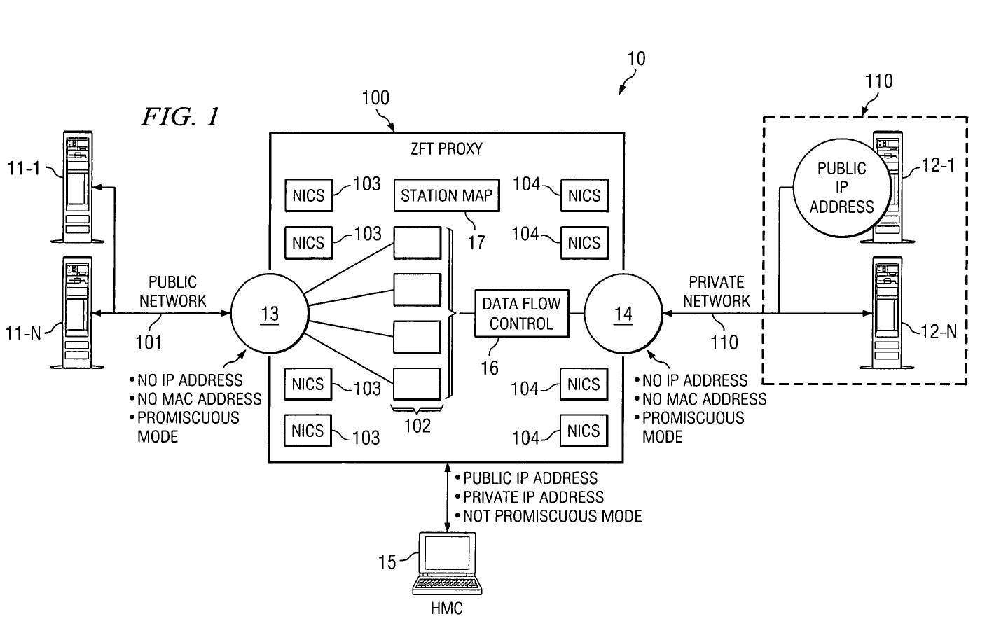

Turning now to FIG. 1, there is shown system 10 with zero footprint proxy 100 replacing visible proxy 22. Zero footprint proxy 100 has a termination point 13 which is invisible to the network in the sense that it has no EP address. Accordingly, when server 11-1, or any other server 11-N, desires to communicate to a device located within network 110, it must send data to its IP address, for example, server 12-1. Interposed on a network between server 12-1 and server 11-1 is zero footprint proxy 100, which intercepts messages at interface 13 and processes the messages to the proper EP address and at the same time filters out or protects the network in whatever way necessary. One such filtering technique is shown in co-pending patent application, U.S. patent application Ser. No. 09/572,112, filed on May 17, 2000, entitled “INTELLIGENT FEEDBACK LOOP PROCESS CONTROL SYSTEM.”

Using the configuration of system 10, a hacker who is attempting to interfere with the operation of private network 110 cannot do so by targeting proxy 100. Thus, a hacker must aim at address 12-1 with the hacker's faulty data. Proxy 100 then “cleans” the input before it arrives at its intended destination. Proxy 100 can be positioned anywhere on the network.

In one embodiment inside zero footprint technology (ZFT) proxy 100, there are a series of computers 102 which operate to process the data, passing it through, (or perhaps store the data) depending on parameters provided to ZFT proxy 100 from time to time.

HMC 15 is a management console which allows an operator to view the operation of ZFT proxy 100. ZFT proxy 100 has within it internal and external network cards or NICS 103, 104, which, in one embodiment, are set to run in what is called the promiscuous mode. The promiscuous mode differs from the normal mode which is utilized in system 20 FIG. 2 in that in the normal mode each NIC has a MAC address which identifies the card (“station”) on the network segment and is used to transfer data on that segment. On the other hand, the IP address is used when data must pass through network routers. At any point in time, data packets having various IP or MAC addresses are on the line, but each data packet is only looked at by the device corresponding to the MAC address of that data packet. The device ignores those data packets not containing the MAC address of that NIC. This is the normal operation of a NIC card. However when the NIC card is in promiscuous mode, it does not use its address matching functions and accepts all of the data packets it sees on the line, and passes that information up the network stack to the application for further processing. Thus, since the NIC is running on promiscuous mode, it needs no MAC address in order to “see” data on the line.

ZFT proxy 100, operating in promiscuous mode, takes all the traffic from inputs 13 or 14 and sends that data to the other interface. In the normal situation, traffic would come in, and the network stack would check to see if the data had to be forwarded. If forwarding is in order, then the data would be sent out the other side of the proxy to the proper IP address. In ZFT proxy 100, all the data that comes in one side goes out the other side to the address as specified in the data itself. This functionality is called bridging. The bridge keeps track, for example, in station map 17, of what equipment MAC addresses are on both sides of the proxy. Thus, if the proxy sees traffic on the outside (public network side) and that traffic is going to another device that also is on the outside of the proxy, it will not copy that traffic. Similarly, if there is traffic going between two different devices sitting on the inside of the proxy (private network), it would not copy that traffic either. The only traffic that is bridged is traffic whose destination places it on the opposite side of the interface.

For example, ZFT Proxy 100 could maintain a station map, such as map 17, containing the MAC addresses of hosts 11-1 through 11-N and 12-1 through 12-N.

If ZFT Proxy is plugged in ahead of the router it will see everything ahead of the router, but if it is plugged in only ahead of a particular department, it will only see the data traffic being sent to or from that particular department. The goal of the user determines where to place the proxy.

The flexibility of the design allows the proxy to be moved around from time to time to isolate certain areas. Thus, it can be put on a cart and plugged into different places to isolate networks on devices for analysis purposes. This could also include packet capture and forensic analysis.

The system checks both ingress and egress data and could, if desired, be set to look at one or the other, but typically it would check in both directions. Since it checks egress, it can be used in portable mode to detect equipment putting improper data onto a network.

In operation, when the system is implemented on Linux, it runs in the application space and when implemented in Solaris, it runs in the kernel space. While a wired network is shown, the network could be wireless or a combination of wired and wireless.

Data flow control 16 can, for example, store information for later delivery, stop information, modify data packets, or take any action appropriate to protect the private portion of the network.

Turning now to FIG. 3, system 30 shows a portion of Internet 31 (or any communication network) where data flows into or out of Internet Service Provider (ISP) 32 packets from Internet 31 would typically have a public destination address which would be translated by a router, such as gateway router 33 to a private internal address. In a typical situation, the devices which are accessible from the Internet which are located in data storage 301 have addresses such as “www.anything.” This address is translated by gateway router 33, such that requests directed to “www.anything” would be routed to processor 301-1 in data storage 301 via gateway 34 and firewall 35.

Note that while the network is set as the Internet, any communication system will work, provided that there is a mechanism at some point in the network for rerouting communication connections upon direction from an external source. In the Internet, as it is known today, data is routed in packets, with each packet containing a portion of a data message and each packet containing an address portion as well as the message and perhaps other portions. Routers along the network serve to route each packet to the proper destination. The Internet is a temporal network in that a stream of packets from one location to another need not flow along any particular path, but, in fact, may take a plurality of different paths between locations. Often, however, entire message streams may take the same route, all depending upon traffic and other conditions as controlled by the network routers. The Internet is a changing network and the invention discussed herein is not limited to the Internet and it is contemplated that as the Internet changes so will the exact implementation of this invention; however, the concepts described and claimed herein are meant to teach those skilled in the art so that they may apply those concepts to an evolving technology without departing from the spirit and scope of this invention.

It should be further noted that the line speeds (1.544 Mbit between gateway router 33 and customer gateway 34 and 10 Mbit between customer gateway 34 firewall 35) are for illustration only, and any desirable speeds can be used. Also note that customer gateway 34 is optional and may not exist in some configurations and router 33 may connect directly to firewall 35, or if no firewall, then directly to server 41.

As will be discussed hereinafter, detection/notification server 41 is the communication path between firewall 35 (which can be any well known firewall, such as a UNIX based computer and data storage 301 for the purpose of protecting the system from unwanted attacks. This process will be discussed in more detail hereinafter with respect to FIG. 4.

Continuing now in FIG. 3, private network 303 (which is a company's internal network) can have any number of terminals, S1-SN, processors 303-2, 303-N and storage devices such as 303-1, and any other number of devices which interact with each other on an internal private network, or which use firewall 35 to access Internet 31 in a well known manner.

The incoming packets are routed from gateway router 33 (or from perhaps a wireless network (not shown)) to firewall 35, then go to detection/notification server 41, which (as will be detailed hereinafter) investigates the quality and quantity of the incoming requests, as well as other factors and determines whether or not a “red line” (defined as a condition wherein unusual action should be performed to protect the viability of the communication system) or other potential trouble situations exist. If a problem exists, detection/notification server 41 sends a command via modem 36 to modem 37 to configuration server 42 to instruct server 42 to perform an action with respect to gateway router 33. This action serves to address the attack by choking down the offending volume by stopping or reducing packet flow through router 33. In addition, detection/notification server 41 addresses the quality of data or the formatting type attacks by investigating the format of the incoming data and determining whether or not the format is acceptable to the processors within data storage 301. Note that modems 36 and 37 are shown essentially as land line telecommunication modems but, of course, could be any form of communications, or combinations could be used, including wireless, a private sub-network independent of the Internet, or even the Internet itself However, since the Internet could be overloaded at this point in time and unless “special” override data can be used, communication external to the Internet (such as, for example, a phone connection or a wireless page message) would be employed. Also, while the communication is shown going to gateway router 33 which is closest to the customer's gateway, the communications could be sent (either concurrently or serially) to more remote routers to begin the process of rearranging the entire network structure so that the information which would have come to “www.anything” or to any other of the Internet addresses associated with this customer would be fully or partially routed to some other location remotely. This alternate location can be a backup processor in a remote location, or a trouble processing center, thereby freeing up the telecommunication capacity at site 301.

Turning now to FIG. 4 there is shown system 40, which essentially consists of detection/notification server 41 and configuration server 42. Information packets come into the detection/notification server from firewall 35 via communication interface 410 and are intercepted by that interface and fed into microprocessor 411. Microprocessor 411 is at the same time loading programs from random access memory 412 which had been stored in disk storage 413. These programs are what logically intercept the incoming data within the random access memory. The programs operate to investigate the incoming data and to make determinations as whether to pass the data on without comment; pass the data on and perform other actions or block the data flow. Some of the other actions that may be taken include, but are not limited to: count packets versus time; count packets versus source; initiate communication with configuration server 42; recognize malformed packets; recognize suspicious or malicious traffic patterns; initiate communications with data servers 301-1, 301-2, and the like; and initiate various notification functions, such as pager and cell phone notification.

Data is accumulated and held in disk storage 413 in conjunction with RAM 412. If no problem exists, the packet is passed along via random access memory 412 to communication interface 415 and via port 301 to the servers where the requests are attended to by the servers in data storage 301. When a trouble situation appears to exist, server 41 performs one or more actions, depending upon the condition. If the condition is that incoming data is formatted improperly, then that data will not be passed along to data storage 301, but will be either held, returned or deleted, and the fact of it will be logged within the disk storage for future reference. Logs are maintained for all action taken and trouble activities. If, on the other hand, a red line process is recognized as a volume error or a flooding condition, then microprocessor 411 will be instructed to load software from disk storage 413 that will activate communication interface 414, thereby activating the link through modems 36 and 37 to send a command to configuration server 42. This command then passes through interface 420 to activate programs stored in random access memory 422, or in storage 423, under control of microprocessor 421. This in turn activates communication interface 424 to gateway router 33 to instruct the router to perform some action to choke down operation that will begin to limit the flooding operation to help solve the red line situation.

The modules that exist in storage 413 are 418-1 through 418-N and represent the software modules that comprise the logic of the system. By changing the programs, parameters and algorithms in storage 413, the system operation can be changed and upgraded for different types of attacks. These system changes, loaded on disk 413, can be manual (from station 44) or remote via the Internet or via any other course, such as wireless or direct connection (not shown) and can occur concurrently with attacks on other systems. Workstation 44 acts as a user interface into the process control system and enables technicians to activate the modules within disk storage 413 to do such things as to view and print the logs via printer 43 to address various settings that comprise the parameters that activate these modules. These parameters are some of the program factors that instruct the microprocessor as to what to do that will ultimately result in the intelligent actions of data storage 301, detection/notification server 42, or configuration server 42. All of these separate modules work together to activate each other in a logical order as will be described hereinafter.

Returning now to FIG. 3, the incoming data packets that come to detection/notification server 41 have within them requests, and these requests are requests of the processors in data storage area 301. It is the processing of these requests that really takes the most amount of time in the process of FIG. 3, so whenever something starts to go wrong, it is usually because the processors in data storage 301 become overloaded either through a volume attack or because of a format situation. The amount of time that it takes the detection/notification server 41 to deal with incoming messages is relatively insignificant with respect to the processing time of data storage 301 so that a little delay is not important.

The data flowing in to server 41 from firewall 35 could be buffered for an amount of time to allow microprocessor 411 to work on the data. However, it is anticipated that such buffering will not be required, and that the data will, if valid, be passed directly through with essentially no time lost. If the data is determined to be invalid, the data will be dropped, (i.e., removed from the data traffic altogether), destroyed, returned or otherwise processed in accordance with the inventive concepts. Also note, that not every packet need be monitored and the degree of monitoring can be dynamically changed up or down depending upon results found. Thus, if an attack is sensed, the monitoring could be increased and the incoming gateway slowed (if desired) to allow for recovery.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A security system for use in conjunction with data flowing from a first device to a second device being directed to said second device in accordance with a network address of said second device, said system comprising:
a security device connected between said first and second devices, said security device accepting packet data for bridging to said second device, said security device operable for observing data flowing from said first device to said second device, said security device not itself having a network address.

2. The security system of claim 1 wherein said first device could be any device on the unsecured side of said security device, each said first device having a unique network address, and wherein said second device could be any device on the secured side of said security device, each said second device having a unique network address.

3. The security system of claim 2 wherein said security device maintains a list of addresses for which it has security responsibility and wherein said security device only observes those data packets containing the network addresses maintained in said list.

4. The security system of claim 3 wherein said list includes addresses of both said first devices and said second devices.

5. The security system of claim 1 wherein said observing comprises:
a monitoring system for gathering information pertaining to the operation of said second device; and
a mechanism for modifying the flow of data into said security system depending upon said gathered information.

6. The security system of claim 5 wherein said gathered information is selected from the list containing:
number of arriving packets in a particular time interval;
the type of requests contained within given packets;
the nature of the informational content of the packets;
the sending identity of the packets;
the destination of the packets;
the traffic patterns formed by packets from specific sources;
the number of arriving packets from specific sources;
the correctness of the packets;
certain data contained in one or more messages; and
the type of file attached to a message.

7. The security system of claim 5 wherein said flow modifying mechanism operates to compare said gathered information with certain pre-established criteria and to set limits, and wherein said operational characteristics of said mechanism is modified in accordance with said set limits.

8. A security device for use in a packet data network where packets are delivered from a sending location to a destination location based upon one or more destination network addresses associated with each packet, said security device comprising:
at least one NIC card for receiving data packets;
a database for maintaining a list of destination network addresses to be secured by said device; and
wherein said at least one NIC card is connected to said network at any point between a sending location and one or more destination locations, said NIC card maintained in promiscuous mode such that said security device can observe all data directed to any destination addresses maintained from time to time in said list.

9. The security device of claim 8 wherein said security device is connected to said network without establishing a network address for said security device.

10. The security device of claim 9 wherein said security device can be moved from location to location on said network without changing any network settings.

11. The security device of claim 8 further comprising:
a plurality of NIC cards all operating in said promiscuous mode.

12. The security device of claim 11 wherein said security device has a zero network footprint while said NIC cards are in said promiscuous mode.

13. The security device of claim 12 wherein all of said NIC cards share the same destination list.

14. The security device of claim 8 wherein said observing comprises:
monitoring system for gathering information pertaining to the operation of said second device; and
mechanism for modifying the flow of data into said security system depending upon said gathered information.

15. The security device of claim 14 number of arriving packets in a particular time interval;
the type of requests contained within given packets;
the nature of the informational content of the packets;
the sending identity of the packets;
the response destination of the packets;
the traffic patterns formed by packets from specific sources;
the number of arriving packets from specific sources;
certain data contained in one or more messages; and
the type of file attached to a message.

16. The security device of claim 15 wherein said flow modifying mechanism operates to compare said gathered information with certain pre-established criteria and to set limits, and wherein said operational characteristics of said gateway router are modified in accordance with said set limits.

17. A method for monitoring data packets arriving at a destination device, said data packets including a network address said packets traveling on a network defined in accordance with said network addresses, said method comprising the steps of:
inserting a security device into said network at a particular location between a sending device and a destination device; and
establishing within said security device the network addresses of said destination device.

18. The method of claim 17 wherein said destination device is a plurality of devices and wherein said establishing step comprises:
establishing all of said plurality of destination devices within said security device.

19. The method of claim 18 wherein at least one of said destination devices is on a public side of said security device so as to monitor data packets egressing from a private side of security device.

20. The method of claim 17 further comprising the step of:
setting said security device to operate in the promiscuous mode.

21. The method of claim 20 further comprising the step of:
modifying the delivery of data to said destination based upon the content of information in arriving data packets.

22. The method of claim 17 wherein said security device does not have a network location address.

23. The method of claim 22 further comprising the steps of:
blocking certain data packets from reaching said destination device;
blocking all packets from reaching said destination device;
load balancing between devices;
modifying the informational content of certain ones of said packets;
unblocking certain hitherto blocked packets, on the basis of certain parameters; and
modifying the informational content of certain ones of said packets.

24. The method of claim 17 further comprising the steps of:
monitoring data packets leaving said destination device; and
selectively modifying the operational characteristics of any network traveled by said data packets based upon the content of said leaving packets.

25. The method of claim 17 wherein said inserting step can be accomplished without changing network configuration settings.

26. The method of claim 17 wherein said inserting step can be performed while said network is operating.

27. The method of claim 17 further comprising the step of:
removing said security device form said particular location while said network is operating.

28. A security device for connection in a data network ahead of a plurality of data destinations to be protected, each said destination identifiable by a unique network address, said security device comprising:
means for accepting data packets from said network without said data packets being addressed to said security device; and
means for passing accepted data packets to particular ones of said data destinations in accordance with destination addresses of said destinations to be detected and maintained for said security device.

29. The security device of claim 28 wherein said maintained destination addresses are stored in a database internal to said security device.

30. The security device of claim 28 wherein said accepting means comprises:
at least one network termination operating in a promiscuous mode.

31. A method of operating a security device connected to a data network ahead of a plurality of data destinations to be protected, each said destination identifiable by a unique network address, said data network having a plurality of nodes, said method comprising the steps of:
accepting data packets from said network without said data packets being addressed to said security device; and
passing accepted data packets to particular ones of said data destinations in accordance with destination addresses of said destinations to be detected and maintained for said security device.

32. The method of claim 31 further comprising:
real time review of certain parameters pertaining to data flowing between nodes of said network;
means for comparing said monitored parameters against stored criteria; and
means for feeding data traffic affecting signals to one or more of said nodes under at least partial control of said comparing means.

33. The method of claim 32 wherein said stored criteria are dynamically changeable.

34. The method of claim 32 further including the step of:
storing certain of said monitored parameters for a period of time, at least some of said stored parameters being useful in determining at least a portion of the communication history of said monitored data.

35. The method of invention claim 32 wherein at least one of said nodes to which data traffic attaches signals is a gateway node to said destination to be protected.
